(19) United States
(12) Patent Application Publication
(10) Pub. No.: US 2010/0026430 A1
(43) Pub. Date: Feb. 4, 2010

(54) SWITCHING DEVICE

(75) Inventors: ERICH ZACH, Brand (AT); RAINER FAAST, Alt-Nagelberg (AT)

Correspondence Address: HENRY M FEIEREISEN, LLC;HENRY M FEIEREISEN, 708 THIRD AVENUE, SUITE 1501, NEW YORK, NY, 10017, US

(73) Assignee: Moeller Gebaudeautomation GmbH, Schrems (AT)

(21) Appl. No.: 12/512,514

(22) Filed: Jul. 30, 2009

Related U.S. Application Data
(60) Provisional application No. 61/085,180, filed on Jul. 31, 2008.

(30) Foreign Application Priority Data
Jul. 31, 2008 (AT) A 1190/2008

(51) Int. Cl. H01H 36/00

(52) U.S. Cl. 335/203

(57) ABSTRACT

A switching device has a magnetic tripping arrangement which includes at least one armature, a coil a yoke, and a yoke sleeve which is formed by at least one first bent part. The armature and the yoke sleeve are hereby arranged in a substantially flush manner, with the coil being arranged substantially around the armature and/or the yoke sleeve. The yoke is arranged about the coil, and the armature is formed for at least indirectly tripping a disconnecting apparatus of the switching device.

### CROSS-REFERENCES TO RELATED APPLICATIONS

This application claims the benefit of prior filed U.S. provisional Application No. 61/085,180, filed Jul. 31, 2008, pursuant to 35 U.S.C. 119(e), the content of which is incorporated herein by reference in its entirety as if fully set forth herein.

This application also claims the priority of Austrian Patent Application, Serial No. A 1190/2008, filed Jul. 31, 2008, pursuant to 35 U.S.C. 119(a)-(d).

### BACKGROUND OF THE INVENTION

The present invention relates, in general, to a switching device.

The following discussion of related art is provided to assist the reader in understanding the advantages of the invention, and is not to be construed as an admission that this related art is prior art to this invention.

Switching devices are known to have a magnetic tripping arrangement to disconnect switching contacts in the case of an occurring short circuit. The magnetic tripping arrangement typically includes a current-carrying coil which is enclosed by a yoke. A movable armature is arranged in the interior of the coil which is accelerated by the magnetic field of the current-carrying coil against an armature spring and causes the disconnection of a movable electric contract from a fixed electric contact during the occurrence of a short circuit. In order to focus the magnetic field lines towards the armature, a yoke sleeve is arranged on the yoke which faces towards the armature, which yoke sleeve is arranged as a turned part by means of metal cutting.

It would be desirable and advantageous to provide an improved switching device to obviate prior art shortcomings and to enable a production thereof with reduced production costs, lower power consumption and less raw material use.

### SUMMARY OF THE INVENTION

According to one aspect of the present invention, a switching device includes a disconnecting apparatus, and a magnetic tripping arrangement including at least one armature provided for at least indirect tripping of the disconnecting apparatus, a yoke sleeve arranged in substantially flush relationship to the armature and formed by at least one first bent part, a coil arranged substantially around at least one member selected from the group consisting of the armature and the yoke sleeve, and a yoke arranged about the coil.

As a result of a switching device according to the present invention, a laborious metal cutting of the yoke sleeve can be avoided. Time and production costs can thus be saved in the production of the yoke sleeve. No waste in the form of valuable metallic material is thus obtained during production of the yoke sleeve. Expenditure for the purchase of material can be lowered in addition to production costs by the lower input of metal. As a result, both the input of power for producing the yoke sleeve as well as the input of raw material will thus decrease. As a result, both the required energy as well as the limited raw materials are used in a responsible manner, and not wasted, thus reducing the burden on the environment.

According to another advantageous feature of the present invention, the yoke sleeve may include a second bent part, with the first bent part being arranged within the second bent part.

According to another advantageous feature of the present invention, the first bent part may be connected with the second bent part by a press fit. As an alternative, the first bent part may be connected with the second bent part in an interlocking or form-fitting manner.

According to another advantageous feature of the present invention, a tappet can be arranged within the yoke sleeve, with an armature spring acting upon the tappet at least indirectly.

According to another advantageous feature of the present invention, at least one member selected from the group consisting of the yoke, the armature and the yoke sleeve may contain a ferromagnetic material.

According to another advantageous feature of the present invention, the coil may have a first connecting lead connected with a terminal of the switching device, and a second connecting lead connected with a fixed electric switching contact of the switching device.

According to another advantageous feature of the present invention, the yoke sleeve may be formed with a yoke shoulder to form a stop when the yoke and the yoke sleeve are assembled together. Suitably, the first and second bent parts of the yoke sleeve define the yoke shoulder, when the first bent part is arranged within the second bent part.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an axonometric view of a magnetic tripping arrangement for a switching device in accordance with the present invention;

FIG. 2 shows a side view of the magnetic tripping arrangement of FIG. 1;

FIG. 3 shows a vertical sectional view of the magnetic tripping arrangement of FIG. 1;

FIG. 4 shows a partly sectional view of the magnetic tripping arrangement of FIG. 3;

FIG. 5 shows an exploded view of the magnetic tripping arrangement of FIG. 1;

FIG. 6 shows a conventional yoke sleeve;

FIG. 7 shows a yoke sleeve in accordance with the present invention, and

FIG. 8 shows an exploded view of the yoke sleeve of FIG. 7.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

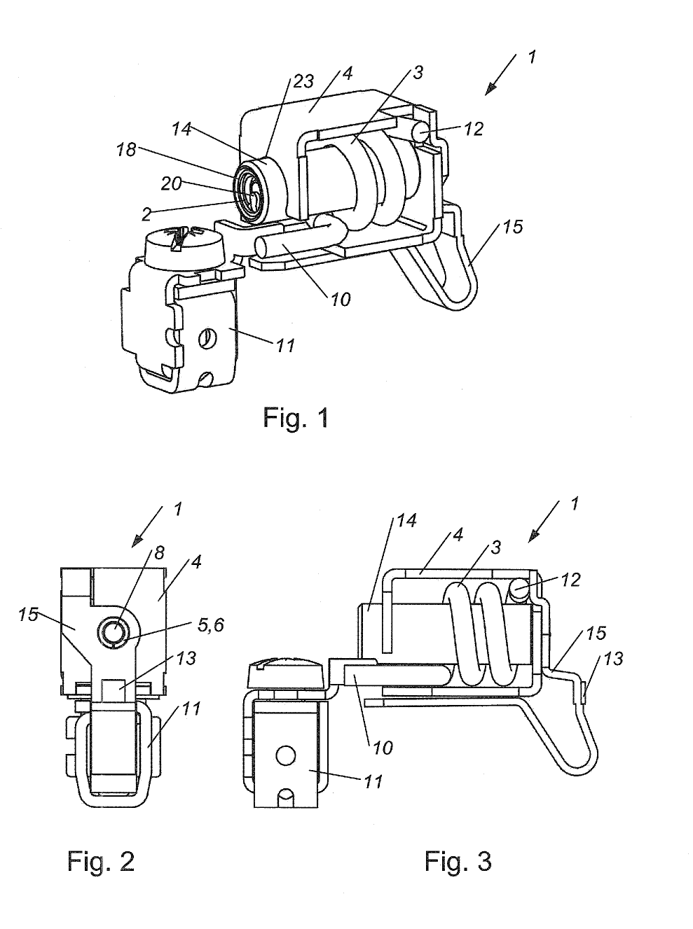

Turning now to the drawing, and in particular to FIG. 1, there is shown an axonometric view of a magnetic tripping arrangement, generally designated by reference numeral 1, for a switching device in accordance with the present invention. The magnetic tripping arrangement 1 includes at least one armature 2, a coil 3, a yoke 4, and a yoke sleeve 5, with the armature 2 and the yoke sleeve 5 being arranged in a substantially flush manner. The coil 3 is hereby arranged substantially around the armature 2 and/or the yoke sleeve 5, with the yoke 4 being arranged about the coil 3, and with the armature 2 being formed for the at least indirect tripping of a disconnecting apparatus of the switching device. The yoke sleeve 5 is formed by at least one first bent part 6, as shown in FIG. 2.

The laborious production by metal cutting of the yoke sleeve 5 can thus be avoided. As a result, time and production costs can be saved in the production of the yoke sleeve 5. No waste in the form of valuable metallic material is thus obtained during production of the yoke sleeve 5. Expenditure for the purchase of material can be lowered in addition to production costs by the lower input of metal. As a result, both the input of power for producing the yoke sleeve 5 as well as the input of raw material will thus decrease. As a result, both the required energy as well as the limited raw materials are used in a responsible manner, and not wasted, thus reducing the burden on the environment.

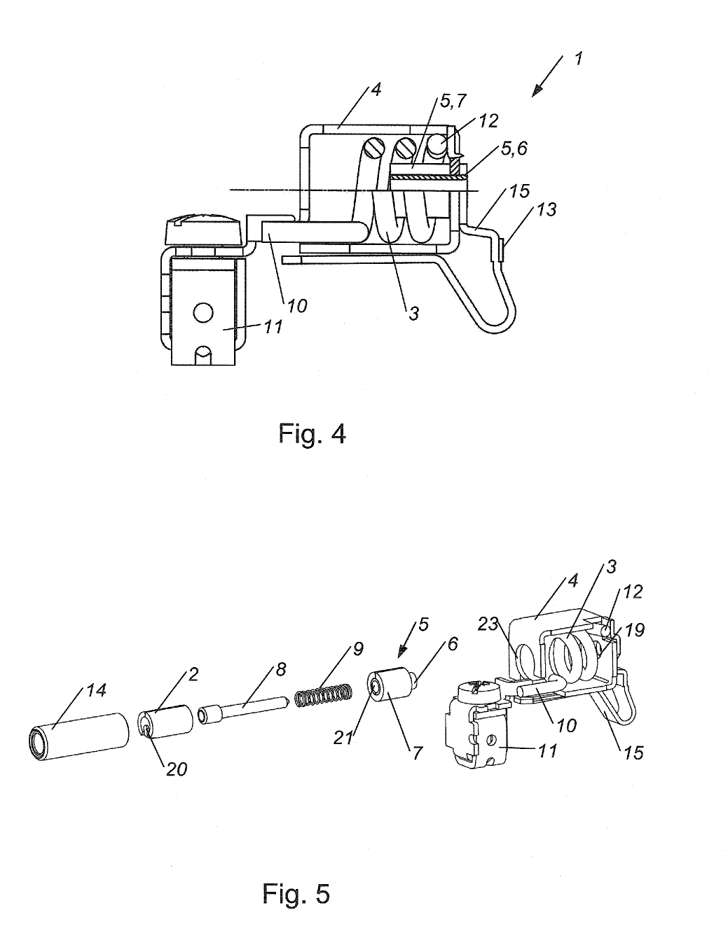

A switching device in accordance with the invention can advantageously be configured as miniature circuit breakers or automatic circuit breakers. The switching device in accordance with the invention includes at least two terminals 11, an input terminal and an output terminal, for the connection of electric conductors to an electric line to be protected. Switching devices with a single breaker gap as well as a predetermined number of electric breaker gaps can both be provided. The switching device in accordance with the invention includes at least one movable electric switching contact for each breaker gap which in combination with a further, preferably fixed, electric switching contact 13 (FIGS. 2-4) forms a pair of switching contacts for making or breaking the electric line to be protected. The at least one movable electric switching contact is preferably moved by a breaker mechanism. Substantially all components of the switching device in accordance with the invention can suitably be arranged within a housing made of insulating material and having breakthroughs for at least one manual actuating lever and for the terminals 11. Switching devices in accordance with the invention are usually arranged in current-carrying outer conductors or phases.

A switching device in accordance with the invention includes at least one magnetic tripping arrangement 1 which is provided for disconnecting the electric switching contacts 13 in the case of a short circuit occurring in the electric line to be protected, therefore a low-impedance connection between an outer conductor or a phase and the neutral conductor. The switching devices in accordance with the invention may further include a thermal tripping arrangement which suitably includes a bimetallic element for tripping the switching device as a result of a slightly increased current flow.

As described above, the magnetic tripping arrangement 1 includes at least one armature 2, a coil 3, a yoke 4 and a yoke sleeve 5. The coil 3 forms within the switching device a part of the electric line to be protected. A first connection lead 10 of the coil 3 is connected with a terminal 11 of the switching device and a second connection lead 12 of the coil 3 is connected with a fixed switching contact 13 of the switching device. The coil 3 is advantageously arranged about a winding support 14 which is made of insulating material and substantially has the shape of a cylinder, at the end of which a shoulder 18 is formed. Coil 3 is enclosed at least in sections by a yoke 4 which is advantageously arranged as a bent or punched sheet metal part and may have the shape of a substantially rectangular box and is used for guiding the magnetic flux. As shown in FIGS. 1 to 5, the second connection lead 12 of the coil 3 is connected with a contact support 15 which supports the fixed electric switching contact 13. The contact support 15 is advantageously also connected with the yoke 4.

The armature 2, which is movable especially along its longitudinal extension, is arranged within the winding support 14 and is guided by the winding support 14, with the armature 2 being pressed by an armature spring 9 in the direction towards an idle position which is preferably formed by the shoulder 18 of the winding support 14. The coil 3, and especially the number and arrangement of the coil windings, and the spring force of armature spring 9 are dimensioned in such a way that the armature spring 9 presses the armature 2 against the idle position in short-circuit-free operation, but in the case of a short circuit accelerates the armature 2 in such a strong manner against the spring force of the armature spring through the electromotive force generated by the coil that its spring force is overcome and the armature 2 moves away from its idle position and causes a tripping of the switching device.

In the non-limiting example of FIGS. 1 to 5, the armature 2 of the magnetic tripping arrangement 1 does not directly trigger the switch, but drives a tappet 8 which is made of an insulating material, so that the armature 2 trips the switch indirectly via the tappet 8. For this purpose, yoke 4 further includes at least one first breakthrough 19 which suitably faces the fixed electric switching contact 13 and through which the tappet 8 acts on a preferably provided breaker mechanism, thus causing the upward movement of the movable switching contact. As best seen in FIG. 5, which shows an exploded view of the magnetic tripping arrangement 1 to illustrate the inner structure thereof, the armature 2 is configured as a hollow cylinder, with a stop 20 for the tappet 8 being formed on its side distal to the first breakthrough 19. Currently preferred is the configuration of the armature 2 in the form of a bent part. As further shown in FIG. 5, the yoke 5 further includes a second breakthrough 23 through which the winding support is guided.

The yoke sleeve 5 is arranged on the yoke 4 in a flush manner in relation to the armature 2 which is arranged within the coil 3 or the winding support 14. The yoke sleeve 5 is used for guiding or leading the magnetic field lines of the magnetic field generated by the coil 3 towards the armature. It is therefore provided that the yoke 4, the armature 2 and/or the yoke sleeve 5 include a ferromagnetic material. The yoke sleeve 5 is advantageously arranged in the region of the first breakthrough 19. Currently preferred is the arrangement of the yoke sleeve 5 at least in sections in the first breakthrough 19, with the yoke sleeve 5 being suitably pressed or riveted together with the first breakthrough 19. The yoke sleeve 5 includes a lead-through opening 21 in order to enable a penetration of the same by the tappet 8.

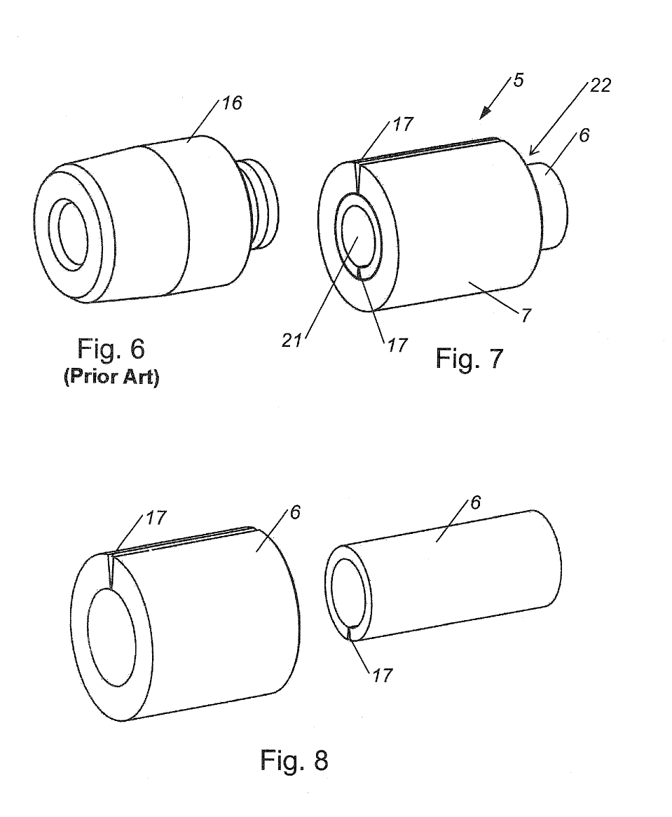

FIG. 6 shows a conventional yoke sleeve 16 which is arranged as a turned part.

In accordance with the present invention, the yoke sleeve 5 is formed by at least one bent part 6. A bent part shall be understood hereby in the widest sense as being a component formed from sheet metal by bending, buckling and/or rolling. The bent part 6 is formed from a substantially rectangular sheet which is bent or rolled into a substantially cylindrical body. The thus-formed yoke sleeve 5 has an air gap 17 in its longitudinal direction which does not cause any noteworthy magnetic losses as the air gap 17 is arranged parallel to the magnetic field lines caused by the coil 3. The air gap 17 ensures reduction of the impairment of the magnetic tripping arrangement 1 by magnetic fields scattered inwardly from the outside, because the air gap 17 represents a considerable resistance for magnetic field lines which are not arranged parallel to the same.

FIGS. 7 and 8 show a preferred embodiment of a yoke sleeve 5 in accordance with the invention which includes a first bent part 6 and a second bent part 7, or is made from the same, with the first bent part 6 being arranged within the second bent part 7. The yoke sleeve 5 has a yoke shoulder 22 which represents an advantageous stop for the automated assembly of the magnetic tripping arrangement 1, thus simplifying the assembly of yoke 4 and yoke sleeve 5. The first bent part 6 is advantageously connected with the second bent part 7 by a press fit according, so that additional measures securing the connection can be omitted and simple and cost-effective production is achieved. As an alternative the first bent part 6 may be connected in an interlocking or formfitting manner with the second bent part 7. Such an interlocking or formfitting connection can be achieved by a knurled outer surface of the first bent part in which a complementary knurled inner surface of the second bent part 7 can engage. This type of connection can also be achieved by a predeterminable plastic deformation of the already assembled first and second bent parts 6, 7. Such an interlocking or formfitting connection will help to achieve an especially secure hold of the first bent part 6 in the second bent part 7.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A switching device, comprising:
a disconnecting apparatus; and
a magnetic tripping arrangement including
at least one armature provided for at least indirect tripping of the disconnecting apparatus,
a yoke sleeve arranged in substantially flush relationship to the armature and formed by at least one first bent part,
a coil arranged substantially around at least one member selected from the group consisting of the armature and the yoke sleeve, and
a yoke arranged about the coil.

2. The switching device of claim 1, wherein the yoke sleeve includes a second bent part, said first bent part being arranged within the second bent part.

3. The switching device of claim 2, wherein the first bent part is connected with the second bent part by a press fit.

4. The switching device of claim 2, wherein the first bent part is connected with the second bent part in an interlocking manner.

5. The switching device of claim 1, further comprising a tappet, which is arranged within the yoke sleeve, and an armature spring acting upon the tappet at least indirectly.

6. The switching device of claim 1, wherein at least one member selected from the group consisting of the yoke, the armature and the yoke sleeve contains a ferromagnetic material.

7. The switching device of claim 1, wherein the coil has a first connecting lead connected with a terminal of the switching device, and a second connecting lead connected with a fixed electric switching contact of the switching device.

8. The switching device of claim 1, wherein the yoke sleeve is formed with a yoke shoulder to form a stop when the yoke and the yoke sleeve are assembled together.

9. The switching device of claim 2, wherein the first and second bent parts of the yoke sleeve define a yoke shoulder to form a stop when the yoke and the yoke sleeve are assembled together.
